(19) United States
(12) Patent Application Publication
(10) Pub. No.: US 2007/0052881 A1
(43) Pub. Date: Mar. 8, 2007

(54) Backlight module with elastic grounding member and liquid crystal display having same

(75) Inventor: Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/515,672

(22) Filed: Sep. 5, 2006

(30) Foreign Application Priority Data
Sep. 5, 2005 (TW) 94130315

(51) Int. Cl. G02F 1/1333

(52) U.S. Cl. 349/58

(57) ABSTRACT

An exemplary backlight module (12) includes a light guide plate (16), a light source assembly (14), a metal frame (13) accommodating the light guide plate and the light source assembly, and an elastic grounding member (15). The light source assembly includes a light source (141) adjacent to the light guide plate and a metal reflector (142) partly surrounding the light source. The elastic grounding member interconnects the metal reflector and the metal frame.

### FIELD OF THE INVENTION

The present invention relates to backlight modules and liquid crystal displays (LCDs) incorporating backlight modules, and particularly to a backlight module configured to reliably ground a metal reflector thereof.

### GENERAL BACKGROUND

A typical liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight module attached to the liquid crystal display.

Referring to FIG. 5, a typical backlight module 100 includes a light guide plate 110, a light source assembly 114, a reflective plate 115, and a metal frame 116. The light guide plate 110 and the reflective plate 115 are disposed in the metal frame 116 in that order from top to bottom.

The light guide plate 110 includes a light incident surface 111, a light emission surface 112 perpendicularly adjoining the incident surface 111, and a bottom surface 113 opposite to the emission surface 112. The reflective plate 115 is located adjacent to the bottom surface 113 of the light guide plate 110. The light source assembly 114 includes a linear light source 117, and a metal reflector 118 generally surrounding three sides of the light source 117. The light source 117 is located adjacent to the incident surface 111 of the light guide plate 110. Because the light source 117 is powered by an external power supply, the metal reflector 118 needs to be connected to ground in order to avoid accumulation of static electricity. In operation, the light source 117 irradiates unwanted electromagnetic waves as well as visible light. The electromagnetic waves are liable to interfere with other electronic elements of a liquid crystal display incorporating the backlight module 100. That is, electromagnetic interference (EMI) is liable to occur. The metal reflector 118 connected to ground can shield a liquid crystal panel of the liquid crystal display and thereby substantially reduce or even eliminate electromagnetic interference.

However, if the backlight module 100 is subjected to shock or jarring, the metal reflector 118 may separate from the metal frame 116. When this happens, the grounding may be imperfect, and the shielding effect may be diminished.

Therefore, a new backlight module and a corresponding liquid crystal display that can overcome the above-described problems are desired.

### SUMMARY

In a preferred embodiment, a backlight module includes a light guide plate, a light source assembly, a metal frame accommodating the light guide plate and the light source assembly, and an elastic grounding member. The light source assembly includes a light source adjacent to the light guide plate and a metal reflector partly surrounding the light source. The elastic grounding member interconnects the metal reflector and the metal frame.

Other advantages and novel features will become more apparent from the following detailed description when taken in conjunction with the accompanying drawings. All the views in the drawings are schematic.

### BRIEF DESCRIPTION OF THE DRAWINGS

FIG. 1 is a schematic, side view of a liquid crystal display according to a first embodiment of the present invention, the liquid crystal display including a backlight module.

FIG. 2 is an exploded view of the backlight module of the liquid crystal display of FIG. 1, the backlight module including an elastic grounding sheet.

FIG. 3 is an isometric view of the elastic grounding sheet of the backlight module of FIG. 2.

FIG. 4 is similar to FIG. 3, but showing an elastic grounding sheet of a backlight module of a liquid crystal display according a second embodiment of the present invention.

FIG. 5 is a schematic, side view of a conventional backlight module.

### DETAILED DESCRIPTION OF PREFERRED EMBODIMENTS

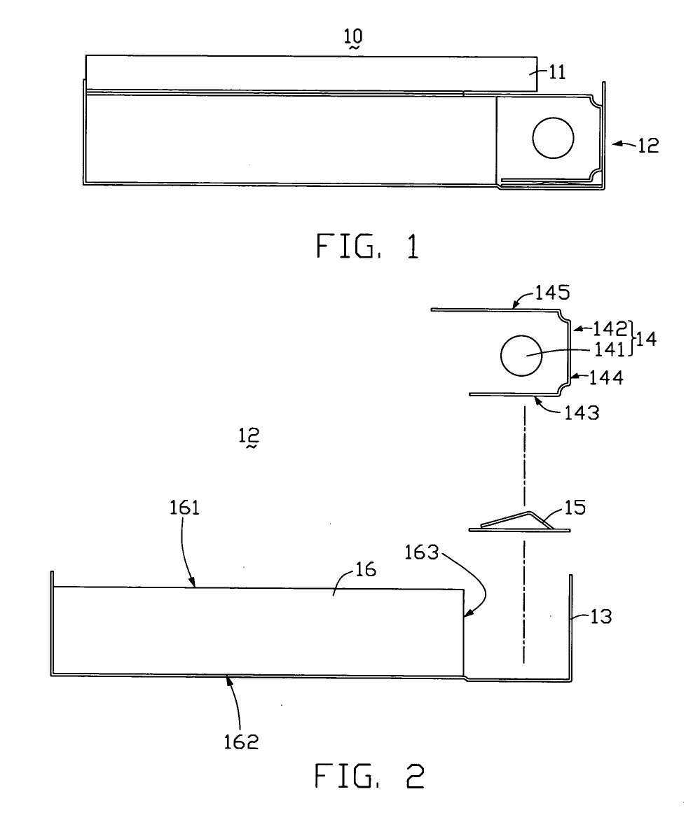

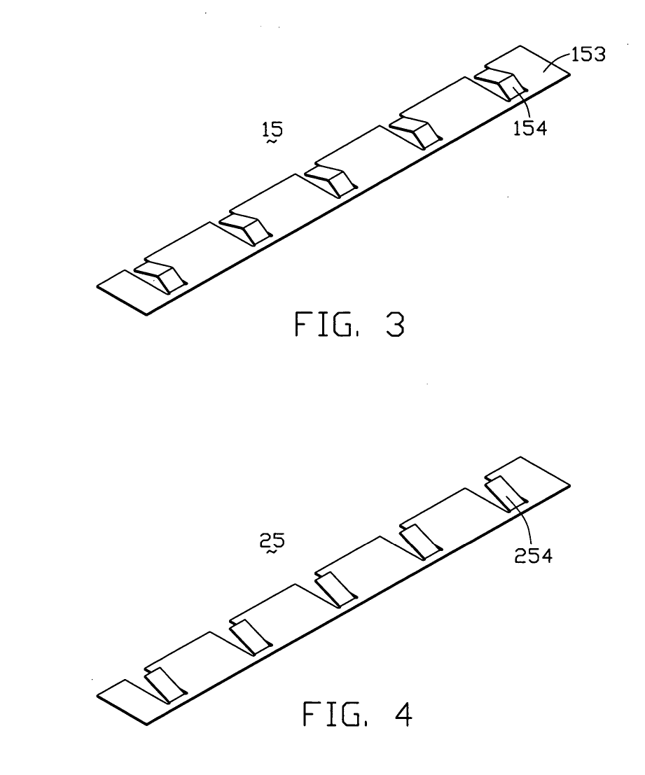

Referring to FIG. 1, a liquid crystal display 10 according to a first embodiment of the present invention includes a liquid crystal panel 11, and a backlight module 12 for illuminating the liquid crystal panel 11.

Referring to FIG. 2, the backlight module 12 includes a light guide plate 16, a light source assembly 14, an elastic grounding sheet 15, and a metal frame 13. The light guide plate 16, the light source assembly 14, and the elastic grounding sheet 15 are accommodated in the metal frame 13. The light source assembly 14 is located adjacent to the light guide plate 16. The elastic grounding sheet 15 is located between the light source assembly 14 and the frame 13.

The light guide plate 16 includes a light incident surface 163, a light emission surface 161 perpendicularly adjoining the incident surface 163, and a bottom surface 162 parallel and opposite to the emission surface 161. The light source assembly 14 includes a linear light source 141 adjacent to the incident surface 163 of the light guide plate 16, and a generally U-shaped metal reflector 142 generally surrounding three sides of the light source 141. The metal reflector 142 includes a first side surface 143 parallel to the bottom surface 162 of the light guide plate 16, a second side surface 144 perpendicular to the first side surface 143, and a third side surface 145 parallel to the first side surface 143. The side surfaces 143, 144, 145 are outer surfaces of the metal reflector 142, and are interconnected by two arc-shaped fillets (not labeled) of the metal reflector 142 respectively. The elastic grounding sheet 15 includes an elongate base 153, and a plurality of elastic contact portions 154 extending from the base 153. Each contact portion 154 has a bent shape. The contact portions 154 are evenly spaced apart along a length of the base 153.

The elastic grounding sheet 15 is disposed between the first side surface 143 of the metal reflector 142 and the metal frame 13. The base 153 contacts the metal frame 13. The contact portions 154 elastically contact the first side surface 143 of the metal reflector 142. Thus, good electrical connection between the metal reflector 142 and the metal frame 13 is established. In an alternative embodiment, the elastic grounding sheet 15 may be disposed between the second side surface 144 of the metal reflector 142 and the metal frame 13. The elastic grounding sheet 15 is made from a metal or a metal alloy, such as stainless steel, beryllium copper, or phosphor bronze.

In summary, the elastic grounding sheet 15 elastically forms mechanical and electrical connection between the metal reflector 142 and the metal frame 13. Thus, the metal reflector 142 is effectively connected to ground. If the liquid crystal display 10 is subjected to shock or jarring, the electrical connection between the metal reflector 142 and the metal frame 13 can remain unimpaired because the elastic grounding sheet 15 buffers the impact.

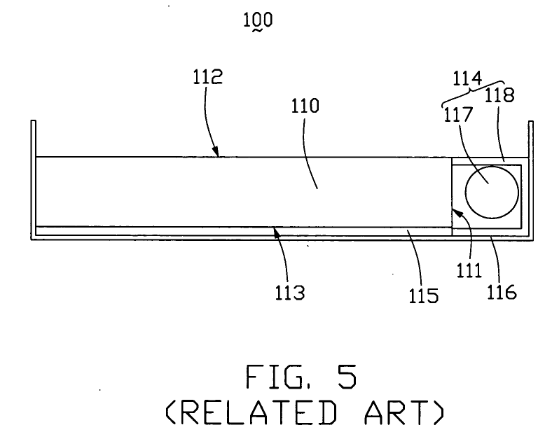

FIG. 4 shows an elastic grounding sheet of a liquid crystal display according to a second embodiment of the present invention. The elastic grounding sheet 25 of the second embodiment is similar to the elastic grounding sheet 15 of the first embodiment. However, the elastic grounding sheet 25 includes a plurality of elastic contact portions 254 that are planar.

In alternative embodiments, the elastic grounding sheet 15, 25 may be locked or welded on the metal frame 13.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate;
a light source assembly comprising a light source adjacent to the light guide plate, and a metal reflector partly surrounding the light source;
a metal frame accommodating the light guide plate and the light source assembly; and
an elastic grounding member interconnecting the metal reflector and the metal frame.

2. The backlight module as claimed in claim 1, wherein the elastic grounding member comprises a base and a plurality of elastic contact portions extending from the base.

3. The backlight module as claimed in claim 2, wherein each contact portion has a bent shape.

4. The backlight module as claimed in claim 2, wherein each contact portion is planar.

5. The backlight module as claimed in claim 2, wherein the contact portions are evenly spaced apart along a length of the base.

6. The backlight module as claimed in claim 1, wherein the elastic grounding member is made from stainless steel.

7. The backlight module as claimed in claim 1, wherein the elastic grounding member is made from beryllium copper.

8. The backlight module as claimed in claim 1, wherein the elastic grounding member is made from phosphor bronze.

9. A liquid crystal display comprising:
a liquid crystal panel; and
a backlight module adjacent the liquid crystal panel for illuminating the liquid crystal panel, the backlight module comprising:
a light guide plate;
a light source assembly comprising a light source adjacent to the light guide plate and a metal reflector surrounding the light source;
a metal frame accommodating the light guide plate and the light source assembly; and
an elastic grounding member interconnecting the metal reflector and the metal frame.

10. The liquid crystal display as claimed in claim 9, wherein the elastic grounding member comprises a base and a plurality of contact portions extending from the base.

11. The liquid crystal display as claimed in claim 10, wherein each contact portion has a bent shape.

12. The liquid crystal display as claimed in claim 10, wherein each contact portion is planar.

13. The liquid crystal display as claimed in claim 10, wherein the contact portions are evenly spaced apart along a length of the based.

14. The liquid crystal display as claimed in claim 9, wherein the elastic grounding member is made from stainless steel.

15. The liquid crystal display as claimed in claim 9, wherein the elastic grounding member is made from beryllium copper.

16. The liquid crystal display as claimed in claim 9, wherein the elastic grounding member is made from phosphor bronze.

17. A backlight module comprising:
a light guide plate;
a light source assembly comprising a light source adjacent to the light guide plate, and a metal reflector partly surrounding the light source;
a metal frame accommodating the light guide plate and the light source assembly; and
an elastic grounding member commoning the metal reflector and the metal frame.
